(19) United States
(12) Patent Application Publication
(10) Pub. No.: US 2004/0164518 A1
(43) Pub. Date: Aug. 26, 2004

(54) Hitch locking mechanism

(76) Inventor: Arnol Staggs, Wyandotte, MI (US)

Correspondence Address: Gerald R. Black, Esq., Suite 160, 30590 Southfield Road, Southfield, MI, 48076, US

(21) Appl. No.: 10/372,507

(22) Filed: Feb. 24, 2003

(51) Int. Cl. B60D 1/28

(52) U.S. Cl. 280/507

(57) ABSTRACT

A hitch locking mechanism enables secure retention of a towing vehicle to a towed vehicle. The hitch locking member comprises a shank and a clamp member. The clamp member includes a base, an arm, and a jaw. The jaw is pivotally attached to the base member, and moves relative to the arm between an upright position and an extended position. The shank is securely affixed to the clamp member at multiple points for secure retention of the towing vehicle to the towed vehicle. A first sleeve is positioned about the shank when the shank is retained to the clamp member. The first sleeve enables rotation of the shank relative to the clamp member when the shank is secured within the clamp member.

### FIELD OF USE

The present invention relates to hitch locking mechanisms, and more particularly, to a unique anti-theft mechanism that is adaptable to many different hitch locking applications.

### BACKGROUND OF THE INVENTION

Trailers attached to pull vehicles are commonly used to transport machinery, livestock and other goods. When the trailer is unhitched from the pull vehicle, the trailer and its goods are subject to theft by undesired coupling to some other towing or pull vehicle.

Various locking mechanisms have been used for trailer hitches. One shortcoming of many of the conventional locking mechanisms is that they rely on an exposed padlock that can be cut quickly and easily by thieves using bolt cutters. One sharp blow with a hammer and chisel can also pop many padlocks open. All of such locking mechanisms are relatively easy to pry off of or out of the protected ball or socket component.

With the increase in towed leisure vehicles, many people have had the unpleasant experience of having a towed vehicle stolen from them. For example, many people go to the trouble and expense to have sturdy chains anchored in the ground and secure the chains to their towed vehicles by padlocks, only to discover that a thief can readily cut a padlock or chain of such an arrangement by using heavy-duty bolt-cutters, a hacksaw or other tool.

Various solutions have been proposed to indicate a secure trailer hitch connection and to alert the driver of the towing vehicle of a loose connection or of theft of the trailer. U.S. Pat. No. 4,230,316 discloses an anti-theft ball for use with ball and socket hitches an externally threaded mounting bolt that engages an internally threaded central opening in the ball. A smaller diameter-locking bolt extends downwardly through a smaller diameter opening in the top of the ball and engages an internally threaded opening in the upper end of the mounting bolt. The threads on the mounting bolt have a different pitch than the threads on the locking bolt. The socket of the hitch prevents access to the locking bolt and the different pitches prevent the mounting bolt from being disengaged. Also, U.S. Pat. No. 5,087,064 discloses an anti-Theft and Safety Device for a Ball and Socket Trailer Hitch. The apparatus prevents the socket of such a hitch from being disconnected from the ball inadvertently or without the owners permission. But nothing was provided to protect the ball.

A conventional Pentel clamp is depicted in FIG. 1. The clamp includes a jaw pivotally attached to a base. A latch holds the jaw in place once the hitch is engaged. The latch has been known to yield under heavy loads and rough road conditions. In addition, the shaft often includes several ball mounts to accommodate varying load conditions. Also, the Pentel clamps also rated for various loads, and more than one clamp is generally needed.

However, these hitches will usually only accommodate trailers of certain sizes and not others. Accordingly, there is a need for an improved type of inexpensive and effective trailer hitch that is easy to assemble and install, that can safely accommodate different size vehicles and loads, that is compatible with various hitch designs, that provides improved wear, that is tamper-resistant to discourage theft of the towed vehicle or the hitch, and upon the unauthorized removal of the hitch from the towing vehicle, sounds a blatant alarm which cannot be deactivated by recoupling the hitch to the towing vehicle.

### SUMMARY OF THE INVENTION

A hitch locking mechanism enables secure retention of a towing vehicle to a towed vehicle. The hitch locking member comprises a shank and a clamp. The clamp includes a base, an arm, and a jaw. The jaw is pivotally attached to the base member, and moves relative to the arm between an upright position and an extended position. The shank is securely affixed to the clamp at multiple points for secure retention of the towing vehicle to the towed vehicle.

A first sleeve is positioned about the shank when the shank is retained to the clamp. The first sleeve enables rotation of the shank relative to the clamp when the shank is secured within the clamp.

A hitch locking mechanism is useful for securing a tow vehicle to a towing vehicle. The hitch locking mechanism comprises a shank, a clamp, and a sleeve. The shank enabling secure retention of a first shank end to a clamp, the shank being cooperatively engageable to a ball mount for attachment to a second shank end, the towed vehicle being attachable to the ball mount. The clamp includes a base and a jaw, the jaw having an upright position and an extended position relative to the base. The jaw is pivotally attached to a base when the clamp is in the upright position and in the extended position, the clamp including a passageway for secure retention of the first shank end. The jaw includes an opening for receiving a fastener, the fastener being engaged when the shank is securely retained to the base member in the upright position and the extended position. A sleeve is positioned about the shank when the shank is retained to the clamp. The sleeve enables rotation of the ball mount when the shank is secured within the clamp.

The preferred embodiment of the trailer hitch assembly of the present invention also includes an alarm unit. The trigger for the alarm unit is preferably a plunger switch that is initially armed when the hitch assembly is installed. Thereafter, the plunger switch is placed in an alarm status, which is used to detect removal of the hitch and/or the towed vehicle.

For a more complete understanding of the hitch locking mechanism of the present invention, reference is made to the following detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention. Throughout the description, like reference numbers refer to the same component throughout the several views.

### BRIEF DESCRIPTION OF THE DRAWINGS

FIG. 1 discloses a hitch clamp mechanism (Pentel clamp) of the prior art:

FIG. 2 discloses a first embodiment of a hitch-locking mechanism of the present invention, the hitch locking mechanism being a Pentel-type clamp comprising a base, a jaw, and an arm, a shank assembly being secured to the arm;

FIG. 3 discloses the clamping member of the embodiment shown in FIG. 2, the clamping member including a base member and a jaw being pivotally secured to the base member (without the shank assembly);

FIGS. 4A discloses the clamping member of FIG. 3 in an upright position, FIG. 4B in a forward position, and FIG. 4C in an extended position;

FIGS. 5A and 5B disclose an assembly view of a first preferred embodiment of the shank assembly of the present invention for use with the clamping member of FIG. 3;

FIGS. 6A and 6B disclose an assembly view of a second preferred embodiment of the shank assembly of the present invention for use with the clamping member of FIG. 3, the shank assembly comprising a ball mount secured to a shank, a ballast member, an inner sleeve and an outer sleeve, and a retaining nut;

FIGS. 7A, 7B, and 7C disclose another embodiment of the hitch locking mechanism of the present invention, FIG. 7A depicting the shank assembly secured within the clamping member, FIGS. 7B and 7C depicting an assembly view of the shank assembly, the shank assembly comprising a shank with a taper at one shank end and a ballast member and a retaining nut at the opposing shank end;

FIGS. 8A and 8B disclose a third preferred embodiment of a shank assembly for the hitch locking mechanism of the present invention (see FIG. 8C), FIGS. 8A and 8B depict a top view and a side view, respectively, of the shank for use in the hitch locking mechanism as depicted in FIG. 8C, the shank including an arm-shank mating opening and a jaw-shank mating opening;

FIG. 9 discloses still yet another preferred embodiment of the hitch locking mechanism of the present invention, the hitch locking mechanism comprising a shank assembly disposed within drop-ball mount, the drop-ball mount being secured to a backing plate, a drawbar extending from the backside of the drop ball mount, the drawbar cooperatively engaging into a receiver tube, the receiver tube being secured to a vehicle cross member;

FIG. 10A discloses the hitch locking mechanism of FIG. 9, having a hitch alarm disposed inside the receiver tube and hidden from view when the drawbar is secured to the receiving tube; FIG. 10B discloses a first embodiment of a plunger switch assembly for use in receiver tube of the hitch locking mechanism of the present invention, the plunger switch assembly abutting the drawbar, the plunger switch assembly being in the armed condition, and FIG. 10C discloses the plunger switch in the activated condition;

FIG. 11A discloses a second embodiment of a plunger switch assembly for use in the hitch locking mechanism of the present invention, the plunger switch assembly abutting the undersurface of the Pentel-type clamp of FIG. 2A, the plunger switch assembly being in the armed condition, and FIG. 11B discloses the plunger switch of FIG. 11A in the alarm condition; and

FIGS. 12A discloses a trailer hitch coupler and FIG. 12B discloses a third embodiment of a plunger switch assembly for use in the hitch locking mechanism of the present invention, the plunger switch assembly abutting the top of the ball mount, the plunger switch assembly being shown in the armed status (with the alarm status in phantom).

### DETAILED DESCRIPTION OF THE PREFERRED EMBODIMENTS

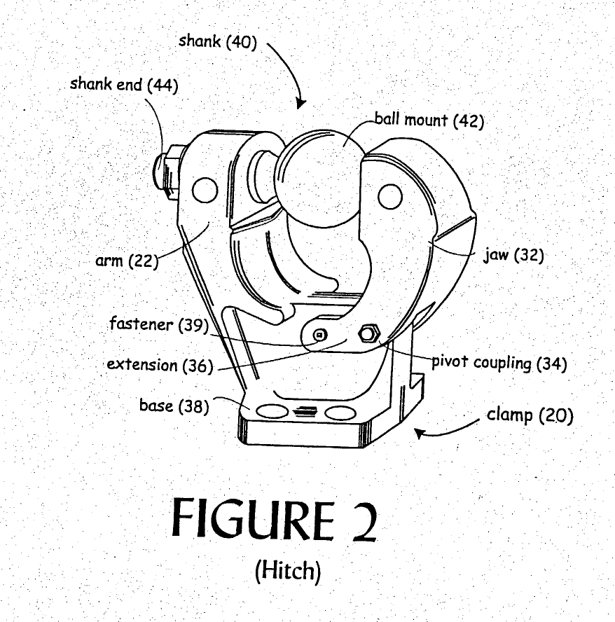

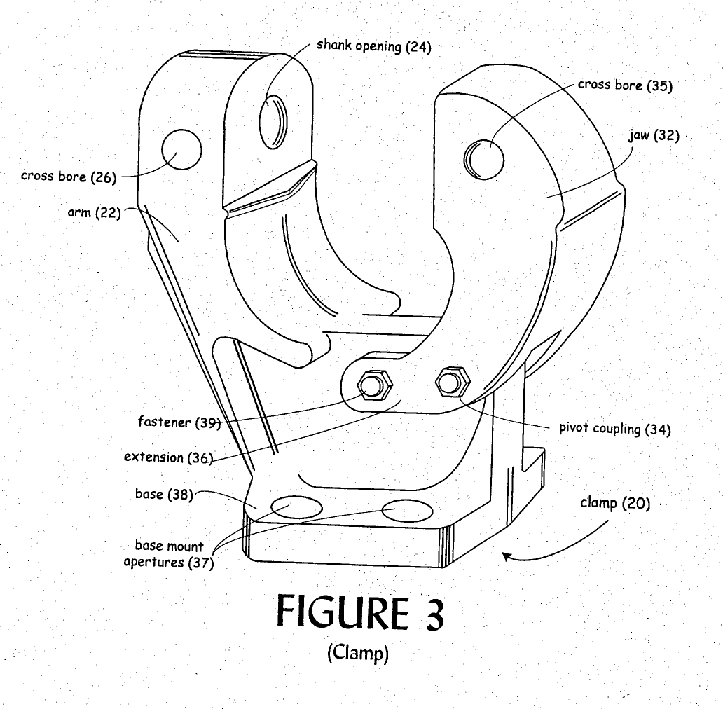

Referring now to the drawings, the preferred embodiment of the hitch locking mechanism of the present invention (10A) is disclosed in FIGS. 2 and 3. As depicted in FIG. 2, the first preferred embodiment of a hitch-locking mechanism of the present invention is a Pentel-type clamp (20) comprising a base (38), a jaw (32), and an arm (22), a shank assembly (40) being secured to the arm (22). FIG. 3 discloses the clamping member (20) without the shank assembly.

A hitch locking mechanism enables secure retention of a towing vehicle to a towed vehicle. The hitch-locking mechanism of FIG. 2A comprises a shank assembly (40A and a clamp (20). The clamp (20) is a modified Pentel-type clamp (20), and includes a base (38), an arm (22), and a jaw (32). The hitch mounting includes a plunger switch (60). The plunger switch (60) is disposed with the recess. The plunger switch (60) has an armed condition (FIG. 2B) and an alarm condition (FIG. 2C).

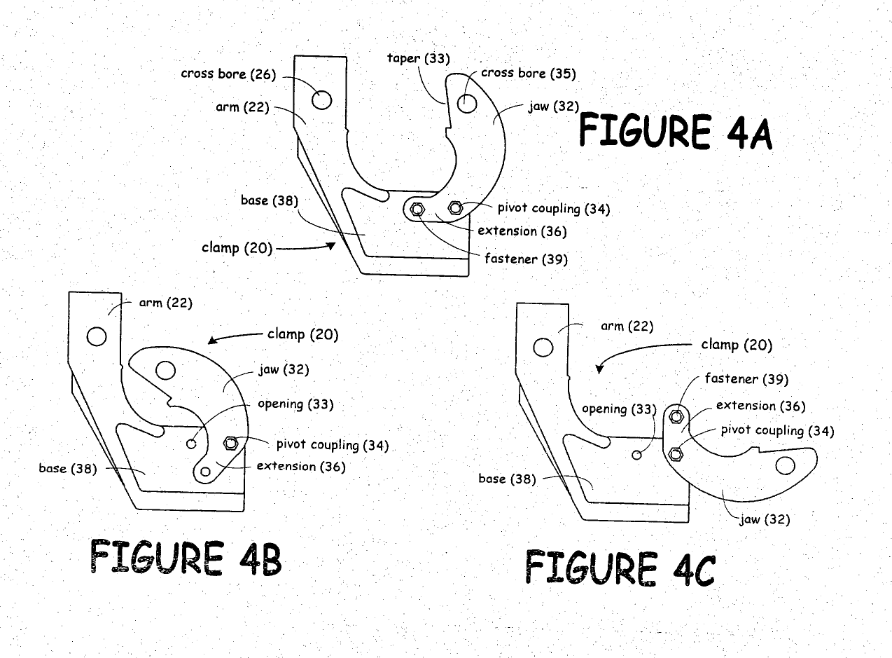

The jaw (32) is pivotally attached to the base (38), and moves relative to the arm (22) between an upright position (see FIG. 4A) and an extended position (see FIG. 4C). The base (38) includes six openings (39) for secure retention to a mounting plate securely retained to the towing vehicle.

FIG. 3 discloses the clamping member of the preferred embodiment the hitch locking mechanism of the present invention as shown in FIG. 2. The clamp (20) is a modified Pentel-type hitch. The modifications include a cross bore in the arm (22) of the clamp (20) that passes through an engaged shank (41). The cross bore enables a shaft to be inserted and engaged with the arm (22) and the shaft, providing additional secure engagement of the shank (41) to the clamp (20). The jaw (32) is pivotally secured to the clamp (20) through a pivotal coupling (34). The jaw (32) also includes a jaw extension (36) extending therefrom. A pair of jaw extension fasteners (39) extending and passing through opening (33) in the base (38) of the clamp (20) reinforce and provide additional strength for the hitch (10A).

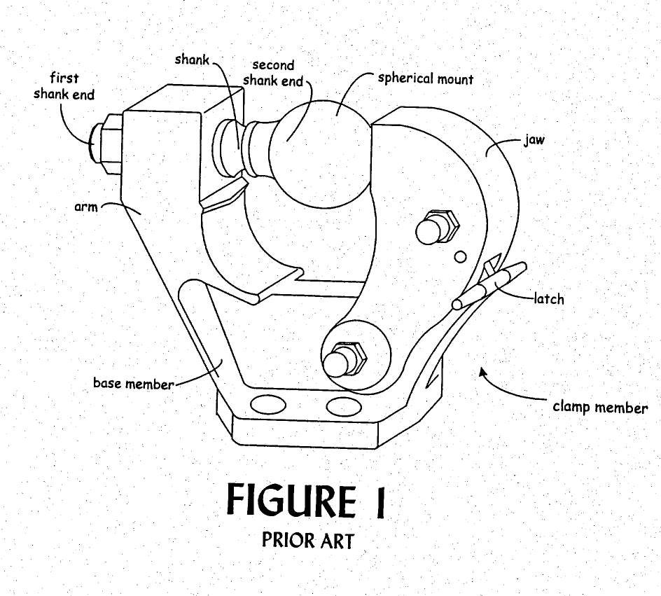

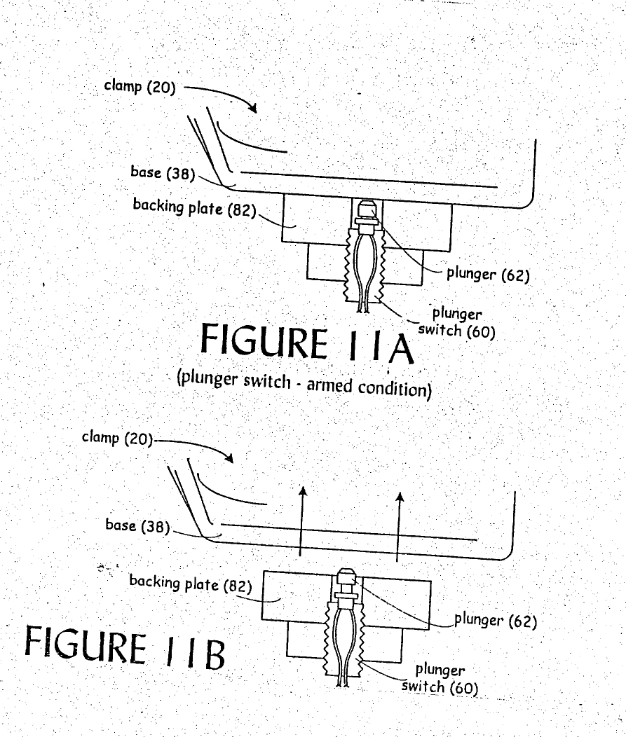

While all of the shank assemblies disclosed herein are designed for the clamp (20), such shank assemblies are also compatible with the shank assembly shown in FIG. 1. Also, various ball mounts (42) can be secured to the shaft to accommodate smaller (about 1⅞″ OD), medium (about 2″ OD), or heavier loads (about 2 5/16″ OD). As shown in the preferred embodiment of the shank assembly of FIGS. 11A and 11B, the shank assembly (40A) is preferably affixed to the clamp (20) at more than one point for purposes of stability of the towing vehicle to the towed vehicle. The shank assembly comprises a shank (41), a ballast (45), and a threaded nut (46). The shank (41) has a ball mount (42) disposed at one end, a collar (47), a threaded body enabling cooperative engagement with the threaded nut (46), and a shank lock opening (43) enabling secure engagement with a lock (not shown). The nut securely retains the shank assembly (40A) to the arm (22) of the clamp (20).

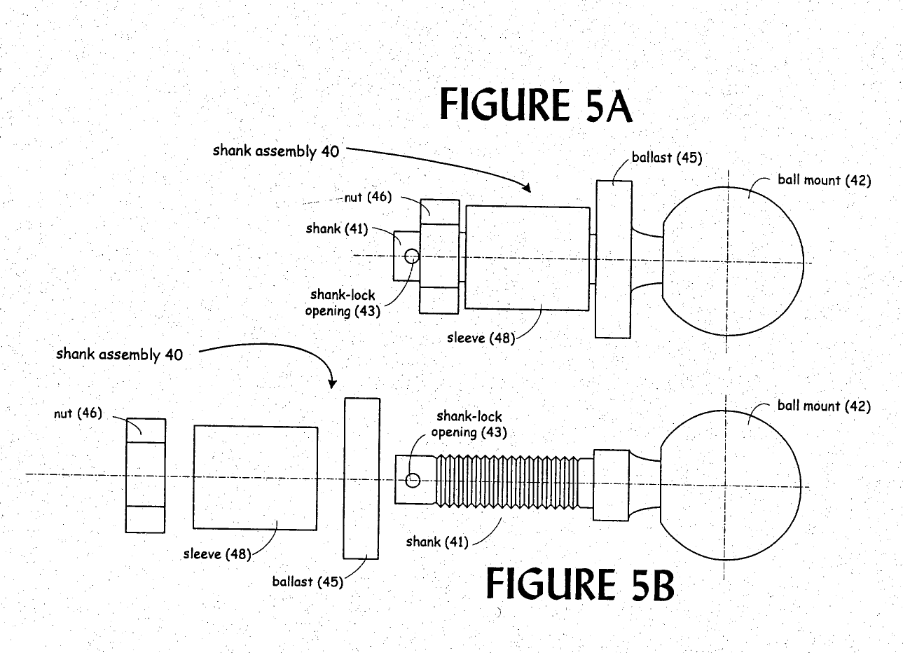

FIGS. 5A and 5B disclose an assembly view of another preferred embodiment of the shank assembly (40A) of the hitch locking mechanism (10A) of the present invention comprises a shank (41), a sleeve (48), a ballast (45), and a threaded retaining nut (46). The shank (41A) passes through a bore (24) disposed in the arm (22) of the clamp (20) along the longitudinal axis of the shank (41A). The arm (22) of the clamp (20) also includes a cross bore (26) enabling a shaft (not shown) to secure retention of the shank (41A) to the arm (22).

The hitch locking mechanism of the present invention secures a tow vehicle to a towing vehicle. The hitch locking mechanism (10A) comprises a shank (51E), a clamp (20), and a sleeve. The shank (51E) enabling secure retention of a first shank end to a clamp (20), the shank (51E) being cooperatively engageable to a ball mount (42) for attachment to a second shank end, the towed vehicle being attachable to the ball mount (42). The clamp includes a base and a jaw (32), the jaw (32) having an upright position and an extended position relative to the base. The jaw (32) is pivotally attached to a base when the clamp (20) is in the upright position and in the extended position, the clamp (20) including a passageway for secure retention of the first shank end. The jaw (32) includes an opening for receiving a fastener, the fastener being engaged when the shank is securely retained to the base in the upright position and the extended position. A sleeve is positioned about the shank (51E) when the shank (51E) is retained to the clamp (20). The sleeve enables rotation of the ball mount (42) when the shank (51E) is secured within the clamp (20).

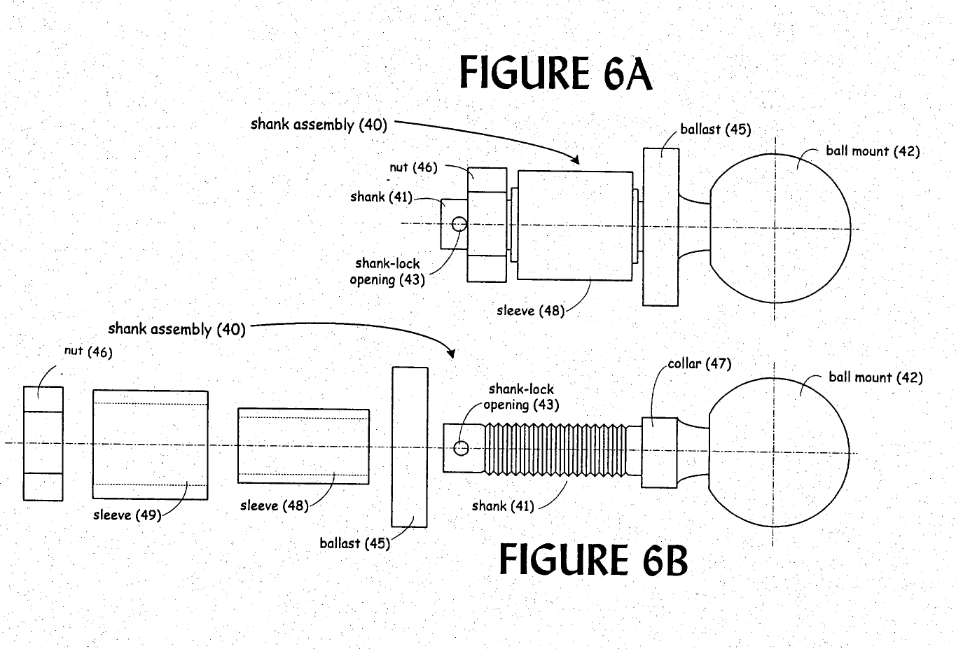

FIGS. 6A and 6B discloses an assembly view of yet another preferred embodiment of the shank assembly (40B) of the hitch locking mechanism (10A) of the present invention is shown. The shank assembly (40B) of comprises a shank (41B), an inner sleeve (48), an outer sleeve (49), a ballast (45), and a nut (46). The external diameter of the outer sleeve (49) fits in a snug manner into the shank opening (24). The external diameter of the inner sleeve (48) is slightly less than the internal diameter of the outer sleeve enabling a rotational movement of the inner sleeve relative to the outer sleeve. Again, this provides additional reinforcement foe the hitch mounting assembly (10A), while again improving wear properties of the ball mount (42). The outer sleeve has an internal diameter that is slightly larger than the external diameter of the shank (41B), enabling the free rotation of the sleeve relative to the shank (41B). This configuration improves wear of the ball mount (42), enabling the ball mount (42) to rotate within the clamp (20), without compromising secure retention of the hitch assembly relative to the towed vehicle. The sleeve combination enables rotation of the shank (41B) relative to the clamp (20) when the shank (41B) is secured within the clamp (20). The threaded nut (46) need only be hand tightened, so that the ball mount (42) can rotate within the sleeve providing more even wear of the ball mount (42).

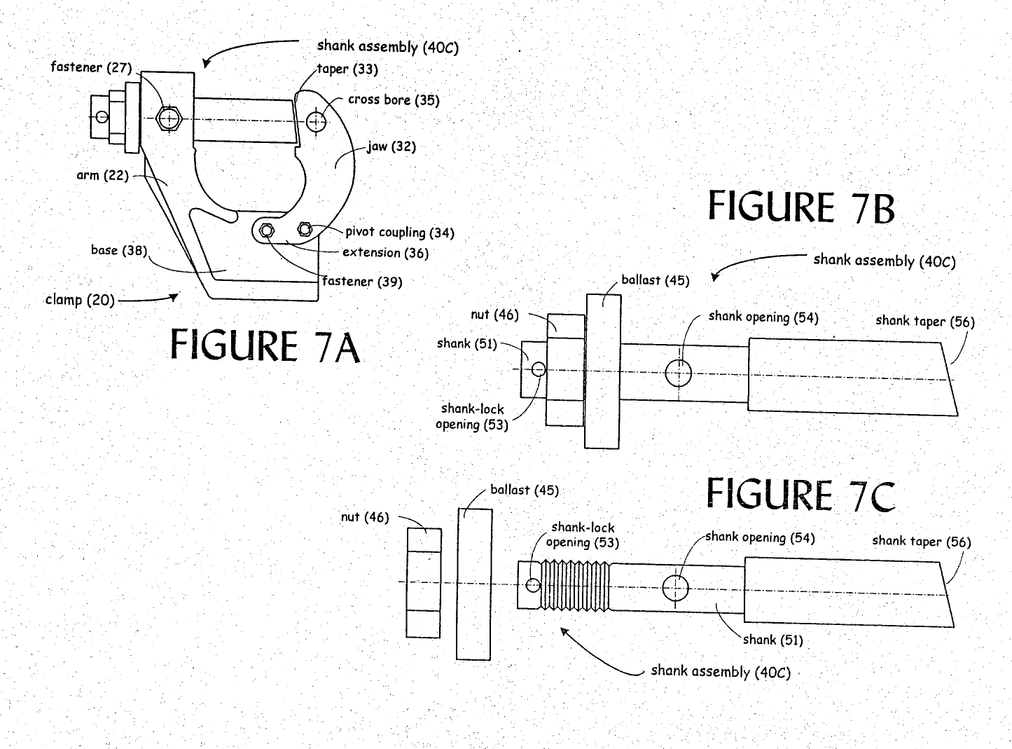

FIGS. 7A and 7B disclose an assembly view of yet another preferred embodiment of a shank assembly (40C) of the hitch locking mechanism of the present invention. The shank assembly (40C) comprises a shank (51), a ballast (45), and a threaded retaining nut (46). The towed vehicle is directly engaged to this shank (51). The shank (51) includes a shank taper (56) at one end that cooperatively engages with a jaw taper (57) having a similar grade to provide additional strength to the hitch locking mechanism of the present invention. The meshing engagement of the tapers (56 and 57) further secures the shank (51) relative to the clamp (20).

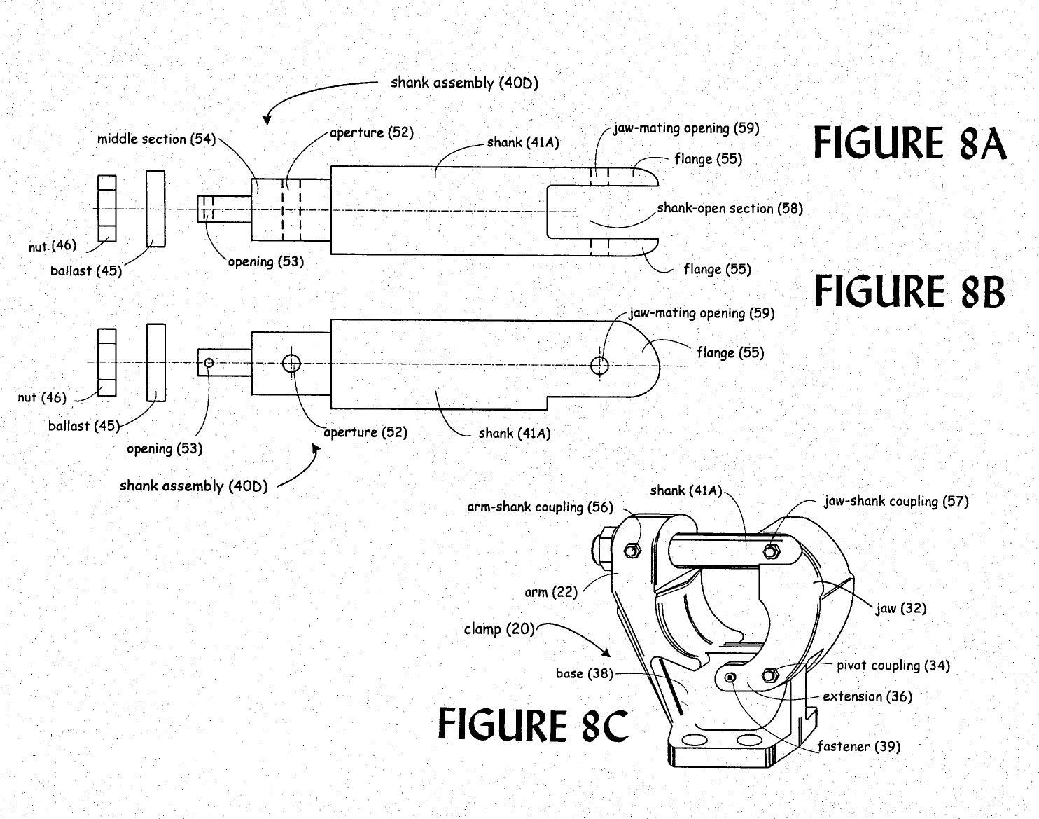

FIGS. 8A and 8B disclose an assembly view of still yet another preferred embodiment of a shank assembly (40C) of the hitch locking mechanism of the present invention. The shank assembly (40C) is useful for towing extra-heavy loads (as much as 10 to 20 tons) because of the multiple engagements between the shank (51C) and the clamp (20)—including the cross bore fasteners (56 and 57) through the arm (22) and the jaw (32), respectively, and a matching taper between the shank (51C) and the jaw (32) not shown. The shank assembly (40C) comprises a shank (51C), a ballast (45), and a threaded retaining nut (46). The towed vehicle is directly engaged to this shank (51C).

FIGS. 8A, 8B, and 8C disclose still another embodiment of the hitch locking mechanism of the present invention. FIGS. 8A and 8B depicts a top view and a side view of the shank (51D), respectively, of the shank (51D) for use in the hitch locking mechanism as depicted in FIG. 8C. An opening (43) is disposed at one end of the shank (51D) for engagement with a lock, an arm-mating opening (52) is disposed in the middle section (53) of the shank and a jaw-mating opening (59) is disposed at the other end of the shank (51D).

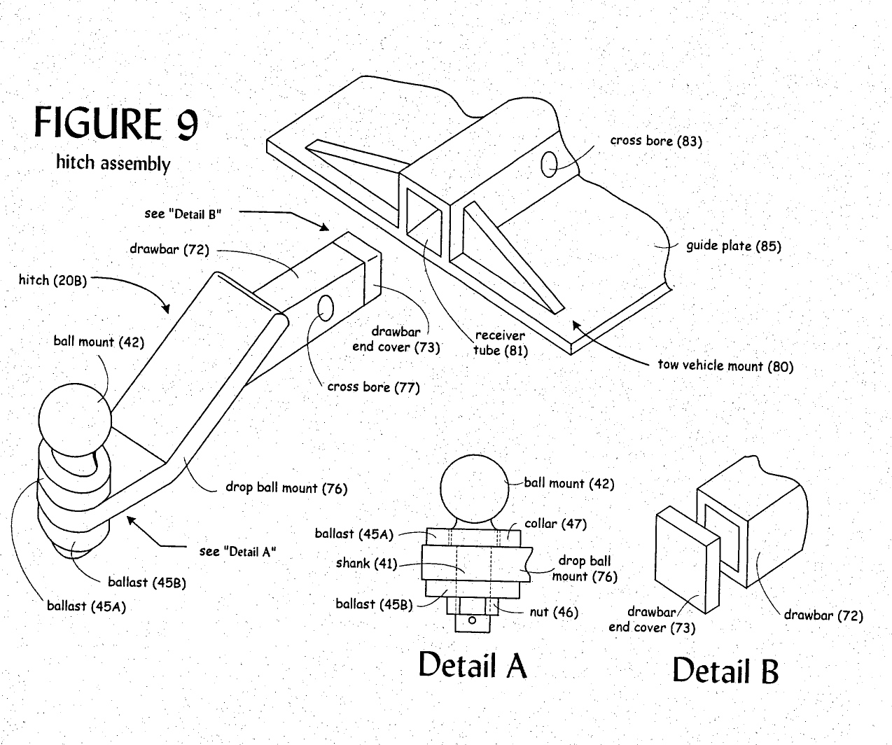

FIG. 9 discloses still yet another view of the hitch locking mechanism of the present invention. This embodiment shows how the principles of the shank embodiments can also be applied to a drawbar hitch (10B). The shank assembly (40C) comprises a shank (51D), an upper ballast (45), a lower ballast (45), and a threaded retaining nut (46). The towed vehicle is directly engaged to this shank (51D). Each of the ballasts (45) is positioned against opposing surfaces of the drop ball mount (76). The drawbar (72) is retained within a receiver tube (81), the receiver tube (81) being secured to the towing vehicle. The drop-ball mount (76) is secured to a backing plate (82), a drawbar (72) extending from the backside of the drop ball mount (76).

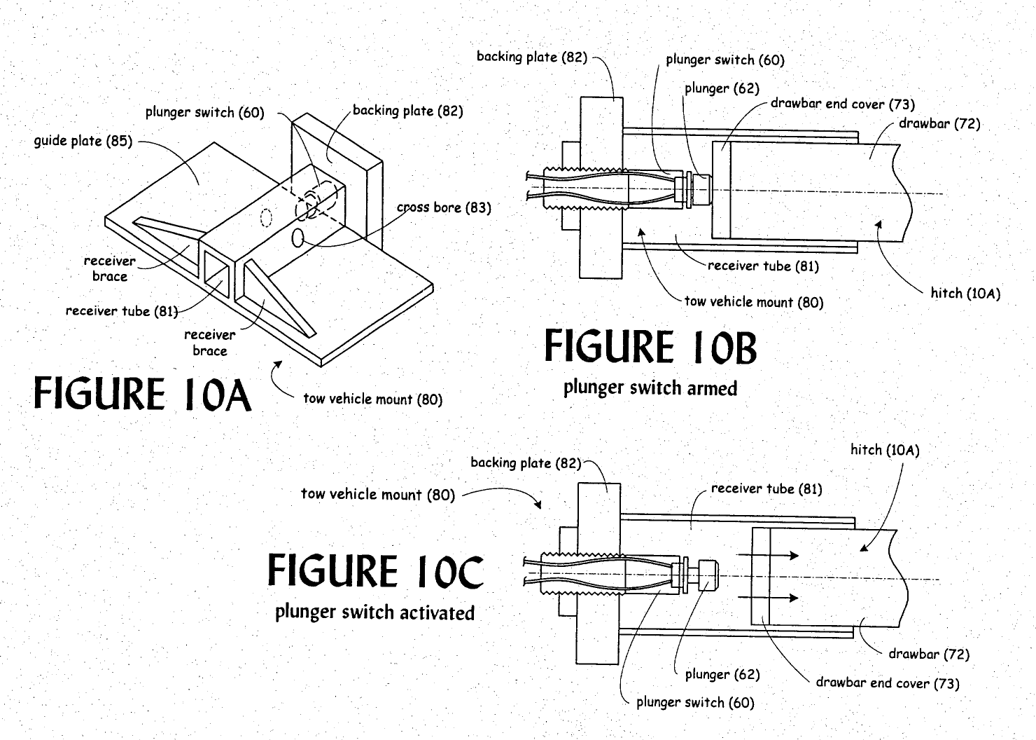

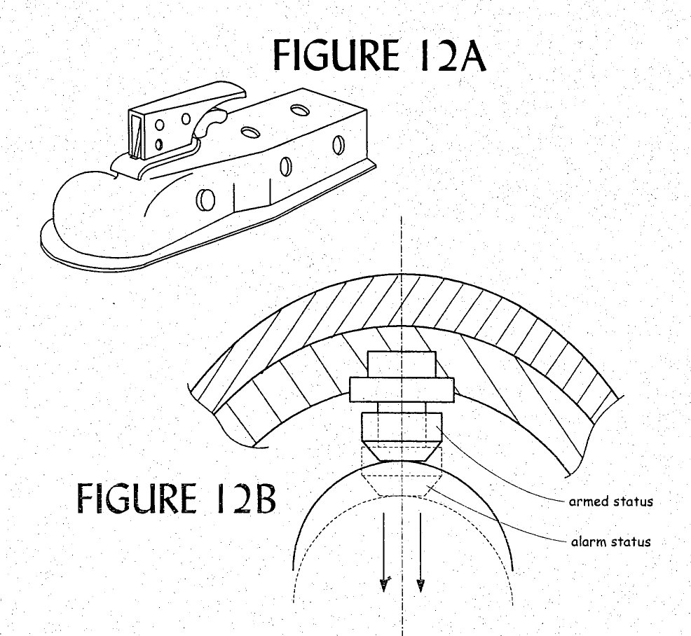

The preferred embodiment of the hitch locking mechanism of the present invention includes an alarm unit. The trigger for the alarm unit is preferably a plunger switch (60) that is initially armed upon installation of the hitch locking mechanism. Thereafter, the plunger switch (60) is placed in an alarm status, and is used to detect removal of the hitch and/or the towed vehicle from the towing vehicle. The alarm unit is depicted with a hitch drawbar (such as the unit shown in FIG. 10A) in FIGS. 10B and 10C; with a Pentel-type clamp (such as the unit shown in FIGS. 2 and 3) in FIGS. 10A and 10B; and with a trailer hitch couple (such as the unit shown in FIG. 12A) in FIG. 12B.

FIG. 10 discloses a refinement to the hitch locking mechanism of the present invention as shown in FIG. 9. The hitch locking apparatus comprises a hitch mounting, a hitch drawbar (72), and an alarm positioned inside the hitch mounting. The hitch drawbar (72) is secured within a receiver tube (81) of the vehicle mounting in such a way as to be invisible when viewed from the outside of the assembly.

FIGS. 10B and 10C depict one preferred embodiment of a unique alarm system for hitch locking mechanisms of the present invention for a drop-ball-type hitch as depicted in FIG. 10A. The hitch mounting is secured to a towing vehicle. The hitch mounting has a recess. The hitch mounting includes a plunger switch (60). The plunger switch (60) is disposed within the recess. A plunger switch (60) is a small button-like device that is spring loaded. The plunger switch (60) has an armed condition (FIG. 10B) and an alarm condition (FIG. 10C). Also, the principles of the plunger switch configuration of the present invention depicted can readily be adapted for other types of hitch designs. The plunger (62) is mounted so that the switch is armed once the hitch is secured to the towing vehicle. The switch moves into an alarm condition whenever the hitch is removed from towing vehicle. The plunger switch (60) is secured to a backing plate. The plunger switch (60) is installed so that the axis of the plunger (62) is aligned with the axis of the drawbar movement within the receiver tube (81). The drawbar (72) is initially inserted into the receiver tube (81). The holes in the drawbar (72) are the aligned with the holes in the receiver tube (81). Then, the plunger switch (60) is inched forward into the backing plate until resistance is achieved—the resistance indicates the plunger (62) has met the drawbar end cover (73) and the plunger (62) is being pushed inward. Such plunger switches are commercially available from Sentrol Industrial a division of General Electric (i.e.-Model #3010)

The armed condition is set once the hitch is secured to a hitch mount, the hitch mount being securely attached to the towing vehicle. The switch is in the alarm condition when the hitch has is withdrawn from the receiver tube (81). The hitch drawbar (72) is mounted onto the towed vehicle, and the hitch drawbar (72) includes a flat surface. The flat surface is a push rod actuator for the plunger switch (60). The flat surface contacts the plunger switch (60) when the drawbar (72) is mounted into the hitch mounting. The plunger switch (60) becomes engaged when the flat surface of the hitch drawbar (72) contacts the plunger switch (60). Withdrawal of the hitch drawbar (72) from the recess of the hitch mounting actuates the plunger switch (60) causing an alarm condition. Further examples of plunger switches can be found in U.S. Pat. No. 5,817,997 (Wernig) and German Publication DE 19532523 (Ebert)

The hitch mounting includes a plunger switch (60). The plunger switch (60) is disposed with the recess. The plunger switch (60) has an armed condition (FIG. 11A) and an alarm condition (FIG. 11B).

A unique alarm system for hitch locking mechanisms of the present invention is shown in FIGS. 2B and 2C (for a Pentel-type hitch). The hitch mounting is secured to a towing vehicle. The hitch mounting has a recess. The hitch mounting includes a plunger switch (60). The plunger switch (60) is disposed within the recess. A plunger switch (60) is a small button-like device that is spring loaded. The plunger switch (60) has an armed condition (FIG. 2B) and an alarm condition (FIG. 10C).

FIGS. 12A discloses a trailer hitch coupler as sold by Reese and designated by them as a Fas-Lok® coupler for a trailer hitch. FIG. 12B discloses a third embodiment of a plunger switch assembly for use in the hitch locking mechanism of the present invention, the plunger switch assembly abutting the top of the ball mount, the plunger switch assembly being shown in the armed status (with the alarm status in phantom). Also, the principles of the plunger switch configuration of the present invention depicted can readily be adapted for other types of hitch designs.

Throughout this application, various patents and publications are referenced by number. The disclosures of these documents in their entireties are hereby incorporated by reference into this specification in order to more fully describe the state of the art to which this invention pertains.

It is evident that many alternatives, modifications, and variations of the hitch locking mechanism of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

I claim:

1. An apparatus for securing a towing vehicle to a towed vehicle by a mounting bracket, the apparatus comprising a shank, the shank enabling secure retention of a first shank end to a clamp member, the shank including a cross bore, the cross bore being normal to a shaft axis, the cross bore for receiving a fastener, the towed vehicle being secured to a hitch through the shank, the hitch for secure attachment to a towing vehicle, the hitch including an opening for receiving the shank, the shank passing through the opening during usage, the hitch including a cross bore for receiving the fastener that passes through the hitch and into the shank, the fastener enabling secure retention of the first shank end and the hitch, and a switch that is armed when the hitch is secured to the mounting bracket that is attached to the vehicle, the switch being in an alarm condition when the hitch is removed from the mounting bracket.

2. The apparatus of claim 1, further comprising a first sleeve positioned about the shank when the shank is retained to the clamp member, the first sleeve having a width, the first sleeve enabling rotation of the shank when the shank is retained within the clamp member,

3. The apparatus of claim 2, further comprising a second sleeve, the second sleeve being disposed between the first sleeve and the shaft, the second sleeve having a width that is greater than the width of the first sleeve, the second sleeve having two ends, the first sleeve end bearing against a shank collar, the second sleeve end bearing against a fastener, the first sleeve being rotatable relative to the second sleeve.

4. The apparatus of claim 1, wherein the shank has a plurality of engagements relative to the arm, a first arm engagement being the arm being secured about the longitudinal axis of the shaft, a second arm engagement being a fastener being secured through the arm and the shaft, the fastener being generally normal to the longitudinal axis of the shaft, a third arm engagement being a fastener being secured to an end of the shank.

5. The apparatus of claim 1, wherein the shank has a plurality of engagements relative to the jaw, a first jaw engagement an acute angle of a second end of the shaft, the second end of the shaft mating with a surface of the jaw having acute angle, the shaft acute angle being similar to the jaw acute angle.

6. A shank member for cooperatively engaging a clamp member, the shank member having an elongated shape, the shank member and the clamp member for towing a vehicle, the clamp member including a base member and a jaw, the shank member comprising a first shank end for secure retention to an arm of a base member, a second shank end enabling secure retention to the jaw of a clamp member.

7. The shank member of claim 6, further comprising a shank center portion, the shank center portion including an opening for receiving a fastener therethrough.

8. The shank member of claim 6, wherein the second shank end includes a pair of shank arms, each of the shank arms extending about an opposite face of the jaw, at least one of the shank arms including an opening for receiving of a fastener coupling.

9. The shank member of claim 6, wherein the shank end includes a taper surface, the taper surface being an acute angle relative to a longitudinal axis of the shank, the second shank end cooperatively engaging a surface of the jaw, the jaw surface including a taper surface, the jaw taper surface engaging the shaft end taper surface.

10. A shank member for cooperatively engaging a clamp member, the shank member having an elongated shape, the shank member and the clamp member for towing a vehicle, the clamp member including a base member and a jaw, the jaw including a pair of opposing surfaces, the shank member comprising a first shank end for secure retention to an arm of a base member, a second shank end including a pair of shank arms, each of the shank arms extending about one of the opposing surfaces of the jaw.

11. The shank member of claim 10, wherein at least one of the shank arms including an opening for receiving a fastener coupling.

12. An apparatus for securing a towing vehicle to a towed vehicle comprising
a. a shank, the shank enabling secure retention of a first shank end to a clamp member, the shank being cooperatively engageable to a spherical mount for attachment to a second shank end, the towed vehicle being attachable to the spherical mount; and
b. the clamp member for secure attachment to the towing vehicle, the clamp member including a base and a jaw, the jaw having an upright position and an extended position relative to the base, the jaw being pivotally attached to a base member, the jaw being securely affixed to the base when the clamp member is in the upright position, the jaw being securely affixed to the base when the clamp member is in the extended position, the clamp member enabling secure attachment to the towing vehicle. the jaw including a pivot fastener, the pivot fastener having a tightened condition, the pivot fastener being in the tightened condition when the jaw member is in the upright position, the jaw of the clamp member including a jaw extension, the jaw extension including means for retaining a fastener attached to the jaw extension when the clamp member is in the engaged position.

13. The apparatus of claim 12, further comprising a first sleeve positioned about the shank when the shank is retained to the clamp member, the first sleeve having a width, the first sleeve enabling rotation of the shank when the shank is retained within the clamp member.

14. The apparatus of claim 12, further comprising a second sleeve, the second sleeve being disposed between the first sleeve and the shaft, the second sleeve having a width that is greater than the width of the first sleeve, the second sleeve having two ends, the first sleeve end bearing against a shank collar, the second sleeve end bearing against a fastener, the first sleeve being rotatable relative to the second sleeve.

15. The apparatus of claim 12, wherein the shank has a plurality of engagements relative to the arm, a first arm engagement being the arm being secured about the longitudinal axis of the shaft, a second arm engagement being a fastener being secured through the arm and the shaft, the fastener being generally normal to the longitudinal axis of the shaft, a third arm engagement being a fastener being secured to an end of the shank.

16. The apparatus of claim 12, wherein the shank has a plurality of engagements relative to the jaw, a first jaw engagement an acute angle of a second end of the shaft, the second end of the shaft mating with a surface of the jaw having acute angle, the shaft acute angle being similar to the jaw acute angle.

17. An apparatus for securing a towing vehicle to a towed vehicle comprising:
a. a hitch mount being secured to a towing vehicle, the hitch mount having a recess, the plunger switch being disposed within the recess, the hitch mount including a plunger switch, the plunger switch being securely retained within the hitch mount, the plunger switch having an armed condition and an alarm condition; and
b. a hitch for mounting onto a towed vehicle, the hitch including a flat surface, the flat surface contacting the plunger switch when the hitch is secured to the hitch mount, the plunger switch becoming armed when the flat surface of the hitch contacts the plunger switch, the plunger switch being in an alarm condition and generating an alarm when the hitch is disengaged from the hitch mount.
